(19) United States
(12) Patent Application Publication
(10) Pub. No.: US 2011/0194110 A1
(43) Pub. Date: Aug. 11, 2011

(54) SPRAY-INSPECTION MACHINE AND METHOD FOR AN ASSEMBLY LINE FOR ASSEMBLING FLUID SPRAY DEVICES

(75) Inventors: Jérôme LANGEARD, Bois Guillaume (FR); Gerallt WILLIAMS, Vironvay (FR); Wilfrid BEAUJOUR, Darnetal (FR); Guy LELOUP, Saint-Aubin-Les-Elbeuf (FR)

(73) Assignee: VALOIS S.A.S, Le Neubourg (FR)

(21) Appl. No.: 13/024,935

(22) Filed: Feb. 10, 2011

(30) Foreign Application Priority Data
Feb. 10, 2010 (FR) FR 10 50923

(51) Int. Cl. G01N 15/02

(52) U.S. Cl. 356/335

(57) ABSTRACT

A spray-inspection machine for an assembly line for assembling a fluid spray device, the machine comprising: a support receiving at least one fluid spray device taken directly from the assembly line; an actuator system for actuating a fluid spray device of said support and for creating a fluid spray; determination means for determining real parameters of said spray created by said actuator system; and analyzer means for analyzing said real parameters, said analyzer means comparing said real parameters with pre-determined parameters, wherein said analyzer means determine parameters relating to spray shape and/or particle size and/or particle density and/or particle-size distribution and/or particle speed.

The present invention relates to a spray-inspection machine and method for an assembly line for assembling fluid spray devices.

### BACKGROUND OF THE INVENTION

Fluid spray devices are well known, and in particular they are used in the fields of perfumery, cosmetics, and pharmacy. In particular in nasal-spray applications, in the pharmaceutical field, the therapeutic effectiveness of the sprayed fluid may depend on the properties of the spray generated while the device is being actuated. In known manner, at the end of the assembly line, i.e. once the spray device is assembled, and just prior to being sent to the fluid manufacturer for assembly onto a corresponding reservoir, a certain number of samples of assembled devices are laboratory tested so as to verify whether the properties of the spray correspond to pre-defined specifications. The drawback of that method is that not only does it take time, but above all it does not enable action to be taken on the assembly line when a fault is detected, since all of the spray devices of the batch from which the tested sample was taken have already been assembled. Documents JP 52119511 and WO 2008/060484 describe such testing methods.

### OBJECTS AND SUMMARY OF THE INVENTION

An object of the present invention is to overcome the above-mentioned drawbacks.

In particular, an object of the present invention is to provide a spray-inspection machine and method that may be used on an assembly line for assembling fluid spray devices.

More particularly, an object of the present invention is to provide such a machine and such a method that make it possible to detect quickly if certain parameters of the spray correspond to pre-defined parameters, and to alert the personnel responsible for the assembly line when a defective device is detected.

Another object of the present invention is to provide such a spray-inspection machine that is simple and inexpensive to manufacture, to use, and to assemble.

The present invention thus provides a spray-inspection machine for an assembly line for assembling a fluid spray device, the machine comprising: a support receiving at least one fluid spray device taken directly from the assembly line; an actuator system for actuating a fluid spray device of said support and for creating a fluid spray; determination means for determining real parameters of said spray created by said actuator system; and analyzer means for analyzing said real parameters, said analyzer means comparing said real parameters with pre-determined parameters, said analyzer means determining parameters relating to spray shape and/or particle size and/or particle density and/or particle-size distribution and/or particle speed.

Advantageously, said support receives a plurality of fluid spray devices, said support being movable relative to said actuator system so as to bring said fluid spray devices successively into said actuator system.

Advantageously, said determination means comprise: a laser device that is adapted to section said spray so as to form a spray section; and a video camera for displaying said spray section.

Advantageously, said actuator system includes a top portion and a bottom portion that are movable relative to each other so as to actuate the fluid spray device and thus create a spray.

Advantageously, said bottom portion co-operates with a reservoir, and said top portion co-operates with a dispenser head of said fluid spray device.

Advantageously, said determination means are programmable.

Advantageously, said video camera displays at least 100 images per second, advantageously at least 500 images per second.

Advantageously, spray-confinement means are provided for receiving the spray generated on each actuation.

Advantageously, said confinement means comprise a chamber and a chimney that is associated with vacuum-generator means, said chimney being disposed above and/or beside the spray device actuated by the machine.

The present invention also provides a spray-inspection method for an assembly line for assembling a fluid spray device, the method comprising the following steps: taking directly from said assembly line at least one assembled spray device; installing it on a support; using an actuator system so as to actuate it and thus generate a spray; determining real parameters of said generated spray; and comparing said real parameters with pre-determined parameters, said real parameters comprising the spray shape and/or particle size and/or particle density and/or particle-size distribution and/or particle speed.

Advantageously, after the step of taking at least one assembled spray device from the assembly line, and before the step of installing it on the support, said spray device is fastened onto a reservoir containing a fluid to be sprayed.

Advantageously, said fluid to be sprayed is water, alcohol, or a mixture of water and alcohol.

Advantageously, the step of determining real parameters of the generated spray is performed with a laser device that is adapted to form a spray section, and with a video camera that is adapted to display said spray section.

Advantageously, the step of determining real parameters of the generated spray comprises determining, with software and from said displayed spray section, spray shape parameters and/or particle size parameters and/or particle density parameters and/or particle-size distribution parameters and/or particle speed parameters.

### BRIEF DESCRIPTION OF THE DRAWING

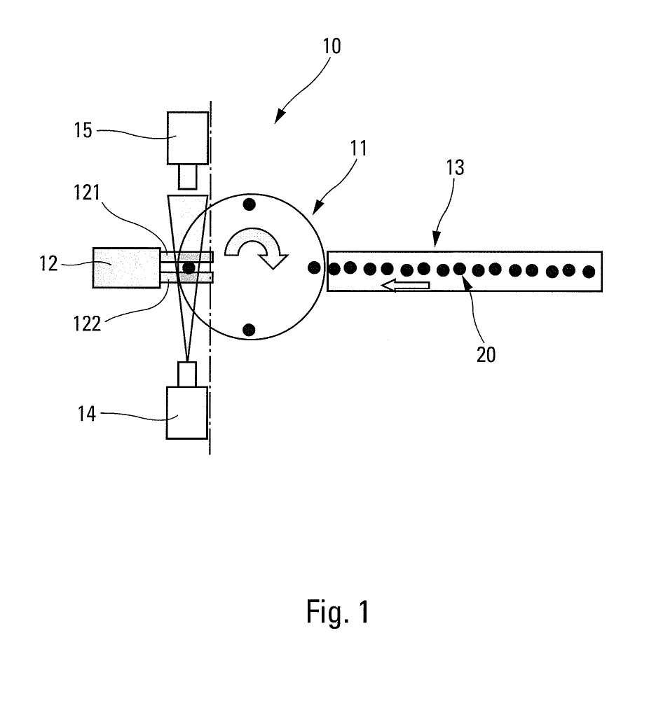

These characteristics and advantages and others of the present invention appear more clearly from the following detailed description made with reference to a particular embodiment thereof, as shown in the accompanying drawing, in which FIG. 1 is a perspective diagram showing a spray-inspection machine in an advantageous embodiment of the present invention.

### MORE DETAILED DESCRIPTION

In the invention, a spray-inspection method is provided that is usable on an assembly line for assembling fluid spray devices. A machine that makes it possible to perform such a method is also described below.

In particular, the term “fluid spray device” means a dispenser member, such as a pump or a valve, with or without a dip tube, associated with a spray head that is provided with a spray orifice. Once assembled, such a spray device is generally delivered to the fluid manufacturer who assembles it onto a reservoir containing the fluid to be sprayed. However, in some circumstances the spray device may equally well be assembled onto the reservoir in the same factory that has assembled the spray device.

The method of the invention proposes taking, directly from the assembly line, at least one spray device after it has been assembled, and installing it on a support, actuating it by means of an actuator system so as to generate a spray, determining one or more real parameters of said generated spray, and finally comparing the real parameters with pre-determined parameters so as to verify whether or not the spray as generated by the actuator system conforms to pre-defined specifications. Advantageously, after the step of taking the assembled spray device, and before the step of installing it on the support, the spray device is fastened onto a reservoir containing a fluid to be dispensed. Preferably, in order to perform the spray inspections, the fluid to be sprayed may be water. In a variant, it is also possible to use alcohol, a mixture of water and alcohol, or any other appropriate fluid. When the spray is generated, determination means are provided for determining real parameters of the generated spray. By way of example, the determination means may comprise: a laser device for creating a laser beam that passes through the spray when said spray is generated; and a video camera that makes it possible to display the spray section formed by said laser beam passing through the spray. Appropriate software associated with a computer thus makes it possible to determine real parameters from said spray section displayed by said video camera, and in particular spray shape parameters and/or particle size parameters and/or particle density parameters and/or particle-size distribution parameters and/or particle speed parameters. Other parameters may also be determined if necessary. The parameters are then compared with pre-defined parameters, and in this way the software can determine whether the spray corresponds to pre-established specifications. An indication or an alert may be given to managers, controllers, and/or users of the assembly line in order to inform them whether or not the tested spray device is in conformity. For example, a light may shine green when the test is positive and red when it is negative. A test report may also be produced for each of the tested samples, and the report may be archived together with the images from the video camera and with the various parameters that have been detected and compared.

FIG. 1 is a diagram showing a machine in an advantageous embodiment of the invention. The spray-inspection machine 10 is advantageously disposed in the proximity of the assembly line so that a user may take one or more spray devices to be tested directly from the assembly line, and install them directly in the inspection machine 10. Optionally, it is possible to provide automatic-loading means if the assembly line assembles each spray device onto a reservoir containing a fluid. Advantageously, the machine includes a support 11 that is adapted to receive a plurality of assembled spray devices 20, e.g. four of them, and said support 11 is movable automatically relative to the actuator system 12 of the machine, so as to bring the spray devices to be tested successively into said actuator system. The support may be of any shape, e.g. circular and rotary, or rectilinear and movable in translation. Advantageously, a rotary support 11 may be associated with a rectilinear track 13 that is adapted to support a larger number of devices, e.g. sixteen, as shown in FIG. 1. The actuator system 12 advantageously includes a top portion 121 and a bottom portion 122 that are movable relative to each other, in particular in translation. This movement makes it possible to actuate the spray device when it is assembled on the reservoir containing water, thereby creating a spray from the water contained in the reservoir. Advantageously, the bottom portion 122, which may be formed by a plate, co-operates with the reservoir, and said top portion 121 co-operates with the dispenser head. Advantageously, the top portion is also formed by a plate that is provided with an orifice through which the spray head passes. In a variant, the actuator system may also be adapted to actuate laterally-actuated spray devices, or to actuate other types of fluid dispenser device, such as dry-powder inhalers (DPI). When the actuator system is actuated, a spray is generated and determination means, preferably programmable means, are used to determine one or more parameters of said spray. As stated above, the determination means may comprise: a laser device 14 that is adapted to create a laser beam that passes through said spray and forms a spray section; and a video camera 15 that is adapted to display said spray section. Advantageously, said video camera 15 displays at least 100 images per second, advantageously at least 500 images per second. Spray-confinement means (not shown) are advantageously provided for containing and receiving the spray generated on each actuation. The confinement means preferably comprise: a chamber that surrounds the entire machine; and a chimney that is associated with vacuum-generator means. The chimney may be disposed above and/or beside the spray device actuated by the machine. Thus, when the spray is generated by the actuator system, it is sucked directly into said chimney so as to avoid soiling the remainder of the machine.

The software is adapted to determine the real parameters quickly, and to compare them with the pre-established parameters so as to provide the result of the inspection quickly. Typically, for each spray device to be tested, a cycle of about 2 minutes enables the required inspections to be performed. With a multiple-support machine as shown and as described above, significant analysis may be performed in a relatively short time, such that the test may be performed in repeated manner along the assembly line so that said assembly line may be inspected almost continuously.

The computer associated with the machine and with the software used advantageously presents a simplified interface via which the user may program the parameters to be analyzed, and may also program the determination means. Advantageously, various parameters are pre-programmed as a function of the type of spray device being assembled on the assembly line, such that the machine may be used with a plurality of assembly lines, for a plurality of different types of spray device.

Various modifications may be envisaged without going beyond the ambit of the present invention, as defined by the accompanying claims.

What is claimed is:

1. A spray-inspection machine for an assembly line for assembling a fluid spray device, the machine comprising: a support receiving at least one fluid spray device taken directly from the assembly line; an actuator system for actuating a fluid spray device of said support and for creating a fluid spray; determination means for determining real parameters of said spray created by said actuator system; and analyzer means for analyzing said real parameters, said analyzer means comparing said real parameters with pre-determined parameters, wherein said analyzer means determine parameters relating to spray shape and/or particle size and/or particle density and/or particle-size distribution and/or particle speed.

2. A machine according to claim 1, wherein said support receives a plurality of fluid spray devices, said support being movable relative to said actuator system, so as to bring said fluid spray devices successively into said actuator system.

3. A machine according to claim 1, wherein said determination means comprise: a laser device that is adapted to section said spray so as to form a spray section; and a video camera for displaying said spray section.

4. A machine according to claim 1, wherein said actuator system includes a top portion and a bottom portion that are movable relative to each other so as to actuate the fluid spray device and thus create a spray.

5. A machine according to claim 4, wherein said bottom portion co-operates with a reservoir, and said top portion co-operates with a dispenser head of said fluid spray device.

6. A machine according to claim 1, wherein said determination means are programmable.

7. A machine according to claim 3, wherein said video camera displays at least 100 images per second, advantageously at least 500 images per second.

8. A machine according to claim 1, wherein spray-confinement means are provided for receiving the spray generated on each actuation.

9. A machine according to claim 8, wherein said confinement means comprise a chamber and a chimney that is associated with vacuum-generator means, said chimney being disposed above and/or beside the spray device actuated by the machine.

10. A spray-inspection method for an assembly line for assembling a fluid spray device, the method comprising the following steps: taking directly from said assembly line at least one assembled spray device; installing it on a support; using an actuator system so as to actuate it and thus generate a spray; determining real parameters of said generated spray; and comparing said real parameters with pre-determined parameters, said real parameters comprising the spray shape and/or particle size and/or particle density and/or particle-size distribution and/or particle speed.

11. A method according to claim 10, wherein, after the step of taking at least one assembled spray device from the assembly line, and before the step of installing it on the support, said spray device is fastened onto a reservoir containing a fluid to be sprayed.

12. A method according to claim 11, wherein said fluid to be sprayed is water, alcohol, or a mixture of water and alcohol.

13. A method according to claim 10, wherein the step of determining real parameters of the generated spray is performed with a laser device that is adapted to form a spray section, and with a video camera that is adapted to display said spray section.

14. A method according to claim 13, wherein the step of determining real parameters of the generated spray comprises determining, with software and from said displayed spray section, spray shape parameters and/or particle size parameters and/or particle density parameters and/or particle-size distribution parameters and/or particle speed parameters.
